(19) United States
(12) Patent Application Publication
(10) Pub. No.: US 2014/0169262 A1
(43) Pub. Date: Jun. 19, 2014

(54) COMMUNICATION METHOD AND APPARATUS FOR MULTI-HOP MULTI-SESSION TRANSMISSION

(71) Applicant: SAMSUNG ELECTRONICS CO., LTD., Suwon-si (KR)

(72) Inventors: Won Jong NOH, Seoul (KR); Jong Bu LIM, Yongin-si (KR); Kwang Hoon HAN, Suwon-si (KR); Chang Yong SHIN, Seoul (KR)

(21) Appl. No.: 13/945,269

(22) Filed: Jul. 18, 2013

(30) Foreign Application Priority Data
Dec. 13, 2012 (KR) 10-2012-0144991

(51) Int. Cl. H04L 5/00

(52) U.S. Cl. CPC H04L 5/0037
USPC 370/315

(57) ABSTRACT

A communication method for multi-hop multi-session transmission, includes forming groups of links operating in cooperation with one another to transmit data concurrently over sessions via relays, controlling interference between the groups, and scheduling the links for the sessions.

### CROSS-REFERENCE TO RELATED APPLICATION

This application claims the benefit under 35 USC 119(a) of Korean Patent Application No. 10-2012-0144991, filed on Dec. 13, 2012, in the Korean Intellectual Property Office, the entire disclosure of which is incorporated herein by reference for all purposes.

### BACKGROUND

1. Field

The following description relates to a communication method and a communication apparatus for multi-hop multi-session transmission.

2. Description of Related Art

Communication environments are being challenged in two fundamental aspects. First, as a number of communication terminals (e.g., smart devices and sensor devices) continues to increase, an amount of traffic from these communication terminals is experiencing a rapid increase. Resolving this issue for cellular communication is particularly difficult. In addition, limited frequency resources are available to support an increasing number of communication terminals and an increasing amount of traffic, and moreover, there is a limitation on improvements to be made to a frequency efficiency in a band currently available. Accordingly, attempts have been conducted to find optical frequency resources in a new band of tens of gigahertz (GHz). However, communication may be unstable due to a short transmission length caused by a high path loss.

As an alternative approach, a multi-hop multi-session-based peer-to-peer or point-to-multipoint communication architecture may allow efficient communication through maximum sharing of frequency resources between terminals. In this case, however, serious interference may occur due to overlapping use of resources among terminals.

### SUMMARY

In one general aspect, there is provided a communication method for multi-hop multi-session transmission, the communication method including forming groups of links operating in cooperation with one another to transmit data concurrently over sessions via relays, controlling interference between the groups, and scheduling the links for the sessions.

In another general aspect, there is provided a communication apparatus for multi-hop multi-session transmission, the communication apparatus including a forming unit configured to form groups of links operating in cooperation with one another to transmit data concurrently over sessions via relays, a control unit configured to control interference between the groups, and a scheduling unit configured to schedule the links for the sessions.

Other features and aspects will be apparent from the following detailed description, the drawings, and the claims.

### BRIEF DESCRIPTION OF THE DRAWINGS

FIG. 1 is a diagram illustrating an example of a network environment for multi-hop multi-session transmission that includes light relays.

FIG. 2 is a diagram illustrating an example of a network model created by generalizing the network environment of FIG. 1.

FIG. 3 is a flowchart illustrating an example of a communication method for multi-hop multi-session transmission.

FIG. 4 is a flowchart illustrating an example of a method of forming cooperative groups based on a spatial degree of freedom (SDoF) in a communication method for multi-hop multi-session transmission.

FIG. 5 is a diagram illustrating an example of parameters used to calculate an SDoF in a communication method for multi-hop multi-session transmission.

FIG. 6 is a diagram illustrating an example of a light relay association procedure in a communication method for multi-hop multi-session transmission.

FIG. 7 is a flowchart illustrating an example of a method of forming cooperative groups based on a network capacity in a communication method for multi-hop multi-session transmission.

FIG. 8 is a diagram illustrating an example of a link scheduling and resource reuse and partitioning in a communication method for multi-hop multi-session transmission.

FIG. 9 is a diagram illustrating an example of a resource reuse between cooperative groups situated near one another in a communication method for multi-hop multi-session transmission.

FIG. 10 is a diagram illustrating an example of an interference reduction between cooperative groups situated near one another in a communication method for multi-hop multi-session transmission.

FIG. 11 is a diagram illustrating an example of a distributed link scheduling for sessions in each of cooperative groups in a communication method for multi-hop multi-session transmission.

FIG. 12 is a diagram illustrating an example of a transmitter group yielding and receiver group yielding in a communication method for multi-hop multi-session transmission.

FIG. 13 is a block diagram illustrating an example of a communication apparatus for multi-hop multi-session transmission.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

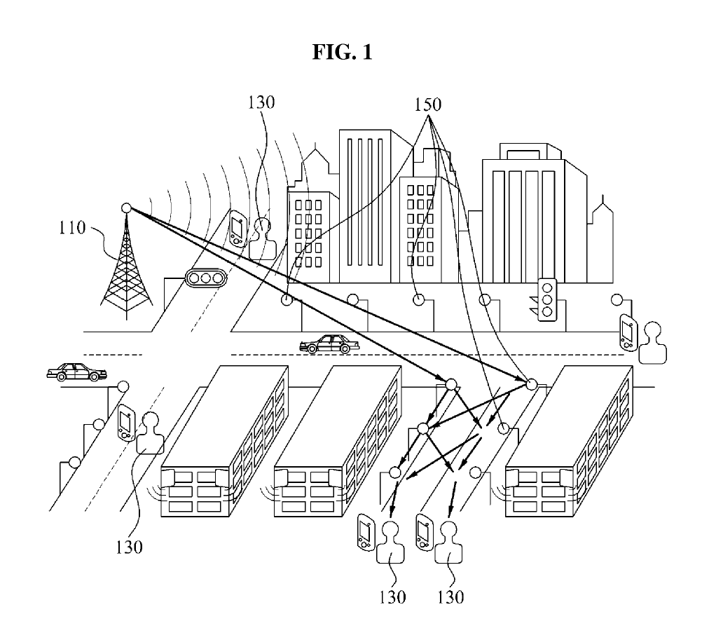

FIG. 1 illustrates a network environment for multi-hop multi-session transmission that includes light relays 150. Referring to FIG. 1, the network environment for multi-hop cooperative communication includes a base station (BS) 110, terminals 130, and the light relays 150.

The BS 110 communicates with the terminals 130 and the light relays 150, using a broad frequency band, for example, a millimeter wave (mmWave) band, and a low frequency band, for example, a long term evolution (LTE) frequency band. The BS 110 transmits data to the terminals 130 directly or via the light relays 150, based on a transmission mode. To support concurrent communication with final receiving terminals, the BS 110 may set the light relays 150 operating in cooperation with the BS 110 or with one another to be a cooperative group. The BS 110 may execute radio resource allocation for the cooperative group of the light relays 150, and may set a cooperation mode. In this example, the direct transmission of the data to from the BS 110 to the terminals 130 may be difficult in urban areas due to frequency properties in the mmWave band.

The light relays 150 may amplify or quantize and forward mixed signals received from different nodes in cooperation with one another. The light relay 150 may correspond to a micro relay node of a terminal level. The light relays 150 may connect to the BS 110 using a wireless backhaul, and may include a maximum transmission power of 30 decibel-milliwatts (dBm) (1 W). Also, the light relays 150 may include mobility, and may include functions of a simpler level than that of a general terminal, for example, basic control, such as channel estimation, amplification or quantization of a mixed signal being received, and signal forwarding. For such functions, the light relays 150 may include, for example, a linear filter, a demodulator, a quantizer, an encoder, a modulator, a multiplexer or mux, and/or an amplifier. The light relays 150 may operate at, for example, 200 milliwatts (mW) maximum.

The light relays 150 may be installed irrespective of locations, and may include, for example, machine-to-machine (M2M) devices of various classes and a wireless mesh BS. Herein, the light relays 150 may be referred to as soft-infra nodes.

The light relays 150 transmits data and controls information, using a first radio resource, for example, an LTE frequency band, and a second radio resource, for example, a mmWave band. For interference exploitation-based concurrent data transmission, the BS 110, the terminals 130, and the light relays 150 operate in cooperation with one another.

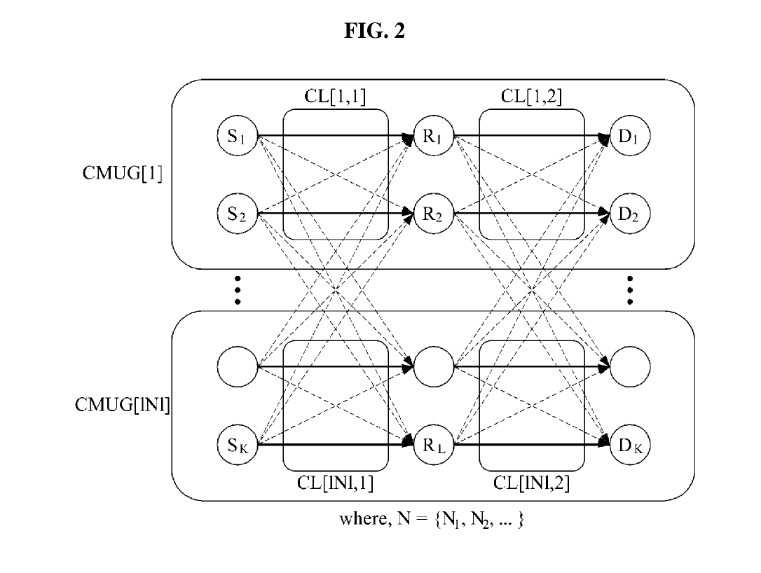

FIG. 2 illustrates a network model created by generalizing the network environment of FIG. 1. Referring to FIG. 2, the network model includes a BS, light relays S₁ to S_{K}, R₁ to R_{K}, and D₁ to D_{K}, and user equipments (UEs). For example, data transmission from the BS to the UEs connected with the destination light relay D₁ may be executed along a multi-hop path, for example, BS→Source Relay S₁→Intermediate Relay R₁→Destination Relay D₁→UEs.

In FIG. 2, a K number of multi-hop unicast transmission sessions from S₁-R₁-D₁ to S_{K}-R_{K}-D_{K} is shown, and are sub-grouped into a |N| number of concurrent transmission cooperative groups. In more detail, each of the cooperative groups are referred to as a cooperative multiple unicast group (CMUG). Each of the cooperative groups correspond to a group of links for concurrent data transmission. For example, a first cooperative multiple unicast group CMUG[1] includes a first hop link CL[1,1] and a second hop link CL[1,2].

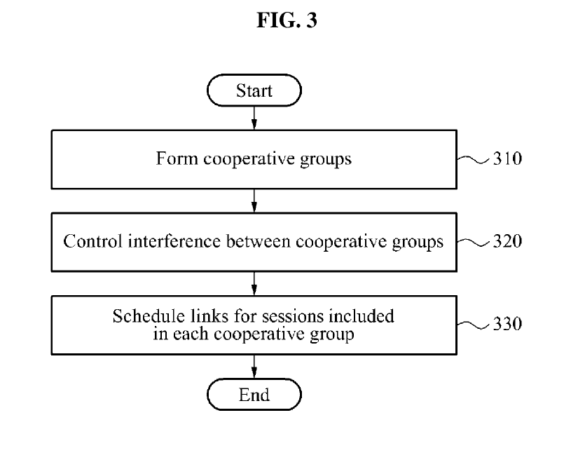

FIG. 3 illustrates a communication method for multi-hop multi-session transmission. Referring to FIG. 3, in operation 310, a communication apparatus for multi-hop multi-session transmission, hereinafter referred to as a communication apparatus, forms cooperative groups of links operating in cooperation with one another to transmit data concurrently over transmission sessions via light relays. The light relays may amplify or quantize and forward mixed signals received from different nodes in cooperation with one another. The communication apparatus may form the cooperative groups based on, for example, one of two methods of maximizing a network utility.

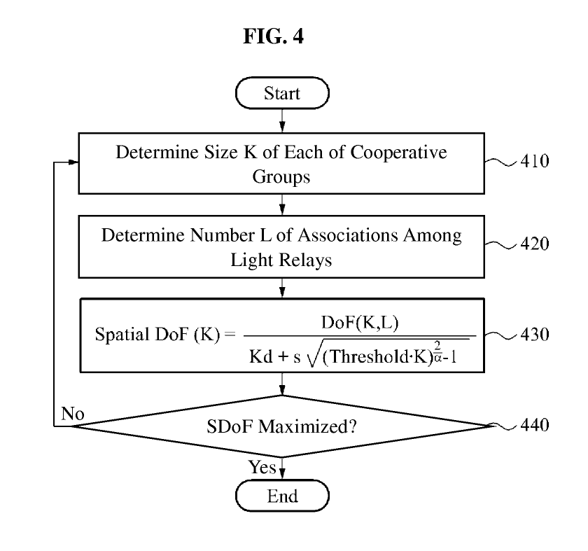

In a first example, the communication apparatus may form cooperative groups based on a sum of degrees of freedom (DoFs) of a network to which the light relays belong. The sum of the DoFs may be determined based on associations among the light relays in the network. For example, the communication apparatus may form the cooperative groups to maximize the sum of the DoFs based on whether a sum of amounts of interference influencing the cooperative groups reaches a threshold value. The threshold value is determined based on a distance between nodes in each of the cooperative groups, and a distance between nodes in different cooperative groups, as represented by the example of Equation 2 below. If the communication apparatus forms the cooperative groups based on the sum of the DoFs of the network, namely, a spatial DoF (SDoF), the communication apparatus may form the cooperative groups without using channel information. A further detailed description of the communication apparatus forming the cooperative groups based on the SDoF is provided with reference to FIG. 4.

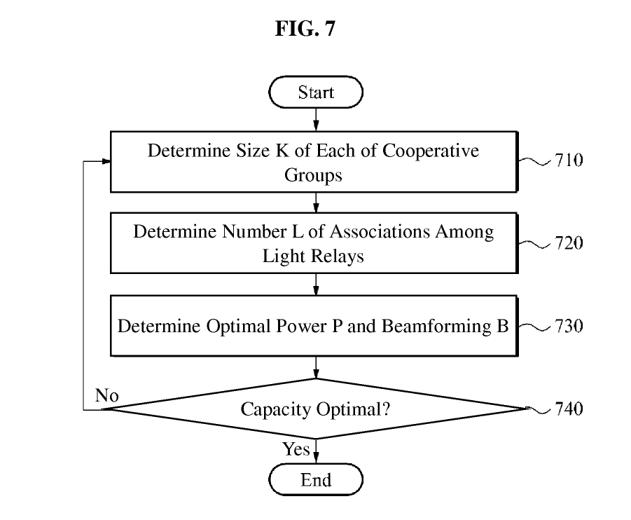

In a second example, the communication apparatus may form cooperative groups based on a capacity of a network to which the light relays belong. The network capacity may be determined based on a transmission power of the light relays, and channel information including transmission beamforming A further detail description of the communication apparatus forming the cooperative groups based on the network capacity is provided with reference to FIG. 7.

In operation 320, the communication apparatus controls interference between the cooperative groups. For example, the communication apparatus may adjust a transmission power among the cooperative groups based on a number of links in each of the cooperative groups. In another example, the communication apparatus may adjust the transmission power among the cooperative groups based on a channel value among the cooperative groups. In this example, the communication apparatus may increase a transmission power of a link in a bad channel condition, and may decrease a transmission power of a link in a good channel condition.

The communication apparatus may execute transmission power control and beamforming control using, for example, zero-forcing (ZF) beamforming, a method of maintaining a total amount of interference of links for sessions in each of the cooperative groups uniformly, a method of maximizing a signal to leakage interference ratio (SLIR), or ZF beamforming in a presence of a significant source of interference or of a boundary relay influencing a strong interference. In the ZF beamforming, each of source nodes may transmit a signal to a null space of an interference channel to prevent transmission links of another group from suffering from interference. As a result, through the ZF beamforming, there may be no need to execute interference reduction among links in a group.

In the method of maintaining the total amount of the interference among the links for the sessions in each of the cooperative group uniformly, if links a1, a2, and a3, for example, are included in a group A, and links b1, b2, and b3, for example, are included in a group B, a total amount of interference among the links a1, a2, and a3 in the group A and the links b1, b2, and b3 in the group B may be maintained uniformly. In this example, even if a number of links in the group A increases, an amount of interference influencing the group B may be maintained uniformly by executing proper beamforming to reduce transmission power of the links in the group A.

In the method of maximizing the SLIR, data may be transmitted from the links of the group A by comparing a signal intensity acquired by destination nodes of the group A to a total amount of interference influencing the group B, and by maximizing a signal-to-interference ratio.

In the ZF beamforming in the presence of the significant source of the interference or of the boundary relay influencing the strong interference, the ZF beamforming or the transmission power control may be executed on nodes located at a boundary between groups exerting significant interference influence on neighboring nodes to prevent the neighboring nodes from experiencing the significant interference.

In operation 330, the communication apparatus schedules the links for the sessions included in each cooperative group. The communication apparatus may execute distributed link scheduling or centralized link scheduling.

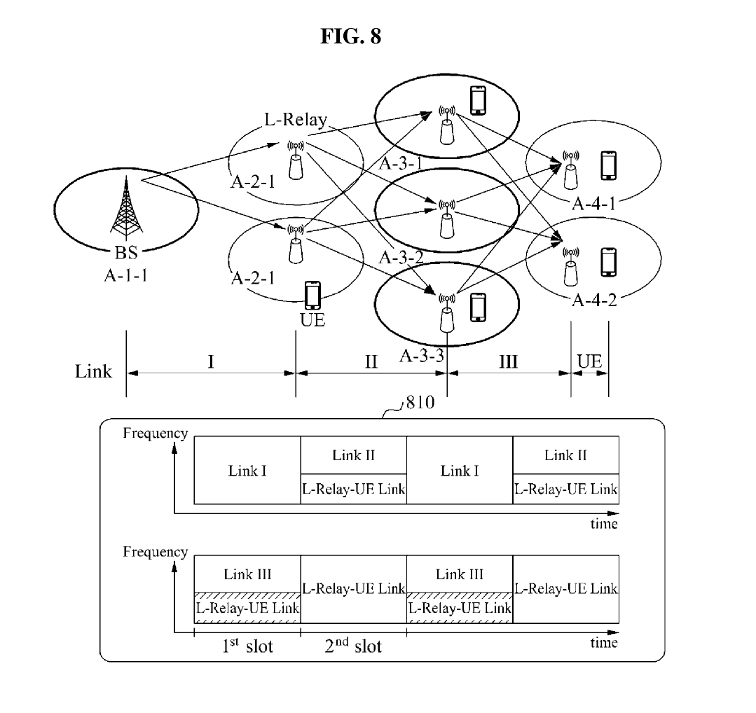

The communication apparatus may partition frequency resources spatially for data being forwarded by the light relays included in the cooperative groups of the sessions, and data placed in the nodes or UEs connected to the light relays, and schedules the links. A further detailed description of the communication apparatus executing resource partitioning and link scheduling is described with reference to FIGS. 8 through 10.

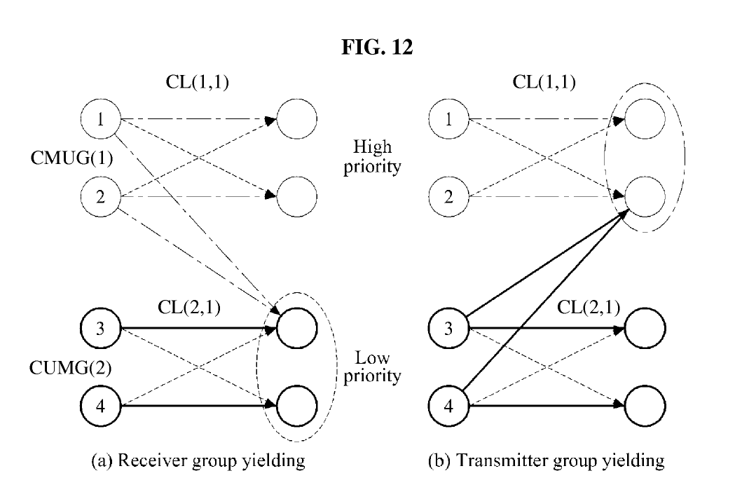

The communication apparatus may schedule the links for the sessions in a distributed manner based on cooperative group yielding. A further detailed description of the communication apparatus executing link scheduling based on the cooperative group yielding is described with reference to FIG. 12.

FIG. 4 illustrates a method of forming cooperative groups based on an SDoF in a communication method for multi-hop multi-session transmission. Referring to FIG. 4, a communication apparatus forms the cooperative groups based on the SDoF of a network to which light relays belong. The DoF of the network may be a number of links enabling concurrent transmission in the network without interference.

The SDoF of the network is determined based on associations between nodes rather than channel information. Optimal grouping based on the SDoF may be equivalent to optimal grouping based on a transmission capacity.

In operation 410, the communication apparatus determines a size K of each of cooperative groups. The size K of the cooperative group corresponds to a number of sessions to be included in each of the cooperative groups, and may be represented as K=S/N, where S denotes a total number of the sessions, and N denotes a total number of the cooperative groups.

In operation 420, the communication apparatus determines a number L of associations among light relays. The number L of the associations among the light relays corresponds to a number of the light relays to be included in each of the cooperative groups, and may be represented as L=R/N, where R denotes a total number of the light relays belonging to a network.

In operation 430, the communication apparatus determines the SDoF based on the determined size K and number L. The SDoF may correspond to an attainable sum of DoFs in the network, and may be represented as the following example of Equation 1:

$$Spatial DoF ( K ) = \frac{DoF \cdot K \text{?}}{Kd + r} \\ \text{?} \text{indicates text missing or illegible when filed} \qquad ( 1 )$$

In Equation 1, DoF(K) denotes a DoF of the network to which the light relays belong. Also, d denotes a distance between nodes in a session or cooperative group, and r denotes a distance between nodes in different sessions or cooperative groups.

A threshold value for an amount of interference among the cooperative groups enabling concurrent data transmission may be calculated based on the following example of Equation 2:

$$\begin{matrix}Threshold = \frac{P \cdot K \text{?} s \text{?}}{KP \text{?} K \text{?} \text{?} {r}^{2} + {s}^{2} \text{?}} \\ = \frac{s \text{?}}{K \text{?} {r}^{2} + {s}^{2} \text{?}}\end{matrix} \\ \text{?} \text{indicates text missing or illegible when filed} \qquad ( 2 )$$

In Equation 2, s denotes a distance between nodes on a link, and α denotes a path-loss coefficient. For example, rough values (i.e., 2 in the free spaces, and 3-5 in the urban areas) of a exist according to the communication environment. Equation 2 may be represented with respect to r as follows:

$$s \sqrt{{( Threshold \cdot K )}^{\frac{2}{α}} - 1} .$$

Accordingly, the SDoF of Equation 1 may be represented as the following example of Equation 3:

$$Spatial DoF ( K ) = \frac{DoF \text{?} K \text{?}}{Kd + s \sqrt{{( Threshold \cdot K )}^{\frac{2}{α}} - 1}} \\ \text{?} \text{indicates text missing or illegible when filed} \qquad ( 3 )$$

The size of each of the cooperative groups may include, for example, a value in a range from 1 to K. Based the SDoF being at a maximum when each of the cooperative groups includes the same size, each of the cooperative groups may be determined to include a size of the same integer value in the range from 1 to K.

In operation 440, the communication apparatus determines whether the determined SDoF is maximized. If the determined SDoF is determined to be maximized, the method ends, and the communication apparatus forms the cooperative groups as in operation 310 in FIG. 3. Otherwise, the communication apparatus returns to operation 410 to redetermine the size of each of the cooperative groups that corresponds to a maximum SDoF by changing or updating the integer value of the size from 1 to S for an optimal SDoF.

For example, if a total number of sessions is ten and a number K of the sessions to be included in each of cooperative groups is two, a total of five cooperative groups in each of which two sessions are sub-grouped may be formed. In this example, to group sessions into each of cooperative groups, or sub-group the sessions within each of the cooperative groups, the sessions may be grouped, for example, in a sequential order at random, or in a sequential order from a smallest cooperation cost.

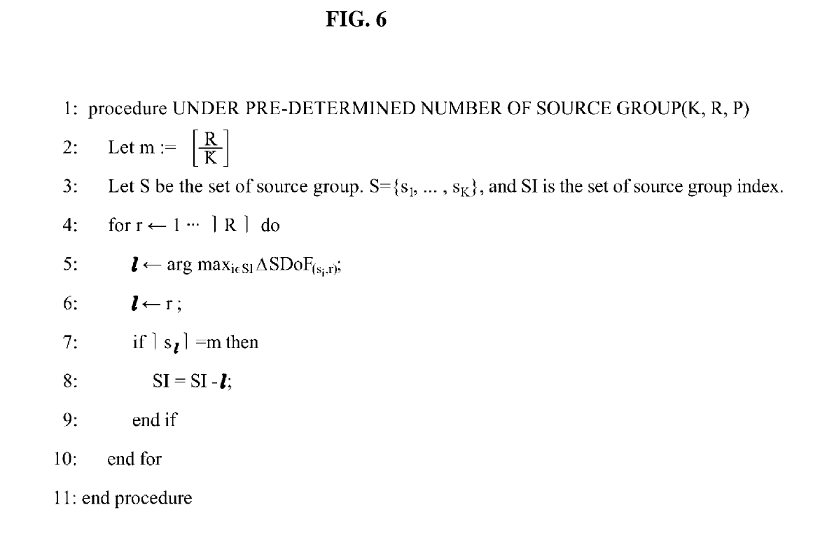

The light relays belonging to the network may be associated with the cooperative groups previously-formed. Based on an SDoF being at a maximum when a number of the light relays associated with each of the cooperative groups is equal, the same number of the light relays may be associated with each of the cooperative groups. For example, if a number of the light relays belonging to the network is twenty, four light relays may be associated with each of the five cooperative groups previously-formed. A further detailed description of the method of associating the light relays with the cooperative groups is provided with reference to FIG. 6.

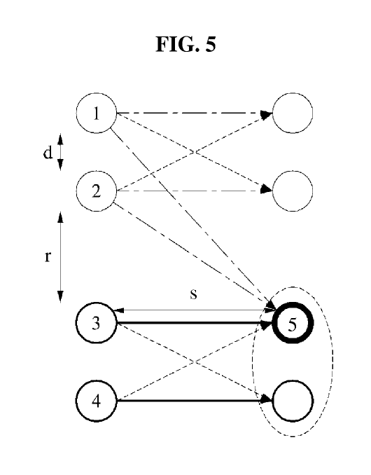

FIG. 5 illustrates parameters used to calculate an SDoF in a communication method for multi-hop multi-session transmission. In FIG. 5, d denotes a distance between nodes (e.g., 1 and 2) in a session or group, and r denotes a distance between nodes (e.g., 2 and 3) in different sessions or groups. Also, s denotes a distance between nodes (e.g., 3 and 5) on a link.

FIG. 6 illustrates a light relay association procedure in a communication method for multi-hop multi-session transmission. Referring to FIG. 6, the procedure includes allocating light relays to a predetermined number of cooperative groups enabling concurrent transmission. Each of the light relays is allocated to a cooperative group allowing a maximum SDoF. A number of the light relays in each of the cooperative groups is determined simultaneously. The procedure is executed from a first light relay to a last light relay in a sequential order, and when m number of the light relays is already present in a selected cooperative group, a next light relay is allocated to a next cooperative group.

FIG. 7 illustrates a method of forming cooperative groups based on a network capacity in a communication method for multi-hop multi-session transmission. Referring to FIG. 7, in operation 710, a communication apparatus determines a size K of each of cooperative groups, namely, a number K of sessions to be included in each of the cooperative groups. The number K of the sessions to be included in each of the cooperative groups may be represented as K=S/N.

In operation 720, the communication apparatus determines a number L of associations among light relays. The number L of the associations among the light relays may be represented as L=R/N.

In operation 730, the communication apparatus determines an optimal transmission power P and an optimal transmission beamforming value B. The determined transmission power and the determined transmission beamforming value may be used to determine a spatial reuse, and corresponds to the network capacity.

As the size K of each of the cooperative groups increases, total leakage power may increase, and consequently, a level of interference influencing a neighboring cooperative group may increase. Accordingly, a probability of transmission failure to the neighboring cooperative group may increase, and an SDoF of a network may decrease.

In an example, the communication apparatus may adjust an amount of leakage interference by adjusting (e.g., decreasing) the optimal transmission power P based on the size K of each of the cooperative groups. The amount of the leakage interference may be understood as an amount of interference influencing links of a neighboring cooperative group rather than links of the same cooperative group. However, the decreased transmission power P may lead to a decreased signal-to-noise ratio (SNR) of each of the cooperative groups, resulting in a decreased capacity of each of the cooperative groups.

Accordingly, in operation 740, determines whether the determined network capacity is optimal. If the determined network capacity is determined to be optimal, the method ends, and the communication apparatus forms the cooperative groups based on the optimal network capacity. Otherwise, the communication apparatus returns to operation 710 to updates the network capacity to be an optimal capacity by changing or updating the size of each of the cooperative groups to an available integer value between 1 and S.

FIG. 8 illustrates link scheduling and resource reuse and partitioning in a communication method for multi-hop multi-session transmission. Referring to FIG. 8, spatial reuse in a uniform network is described.

In a layered network structure, data may be transmitted from a BS A-1-1 to first hop light relays (L-Relays) A-2-1 and/or A-2-2 via a Link I, may be transmitted from the first hop light relays A-2-1 and/or A-2-2 to second hop light relays A-3-1, A-3-2 via a Link II, and/or A-3-3, and may be transmitted from the second hop light relays A-3-1, A-3-2, and/or A-3-3 to final hop light relays A-4-1 and/or A-4-2 via a Link III. The first hop light relays A-2-1 and/or A-2-2 may serve the second hop light relays A-3-1, A-3-2, and/or A-3-3, and user equipments (UEs) connected directly to the first hop light relays A-2-1 and/or A-2-2. A Link UE corresponds to a final link that serves only UEs of the Link UE, absent relaying to a next link, and accordingly, may use all frequency regions for the UEs of the Link UE.

Reference about the link scheduling and the spatial reuse for the light relays included in each of the Links I through UE is made to reference number 810. In this example, a unit of the link scheduling is a slot.

In a first slot, the Links I and III are scheduled to transmit data concurrently using all frequencies. Accordingly, the Links I and III may use a frequency region (e.g., “Link I” and “Link III”) for data to be relayed, and a frequency region (e.g., “L-Relay-UE Link”) for UEs connected to the Links I and III, separately. If the links operate in a half-duplex mode, the Links II and UE are in idle transmission.

In a second slot, the Links II and UE are scheduled to transmit data concurrently. That is, data being relayed by the Links II and UE, and data to be transmitted to UEs connected to the Links II and UE, may be present in the Links II and UE concurrently. Accordingly, the Links II and UE may use a frequency region (e.g., “Link II” and “L-Relay-UE Link”) for data to be relayed, and a frequency region (e.g., another “L-Relay-UE Link”) for UEs connected to the Links II and UE, separately.

The communication apparatus may adjust a frequency region used to relay to a next hop, and a frequency region used to serve UEs, dynamically at a relative traffic ratio. That is, the communication apparatus may adjust a region of a frequency resource dynamically at the relative traffic ratio of a link for data being relayed by the light relays, and a link for data placed in nodes connected to the light relays.

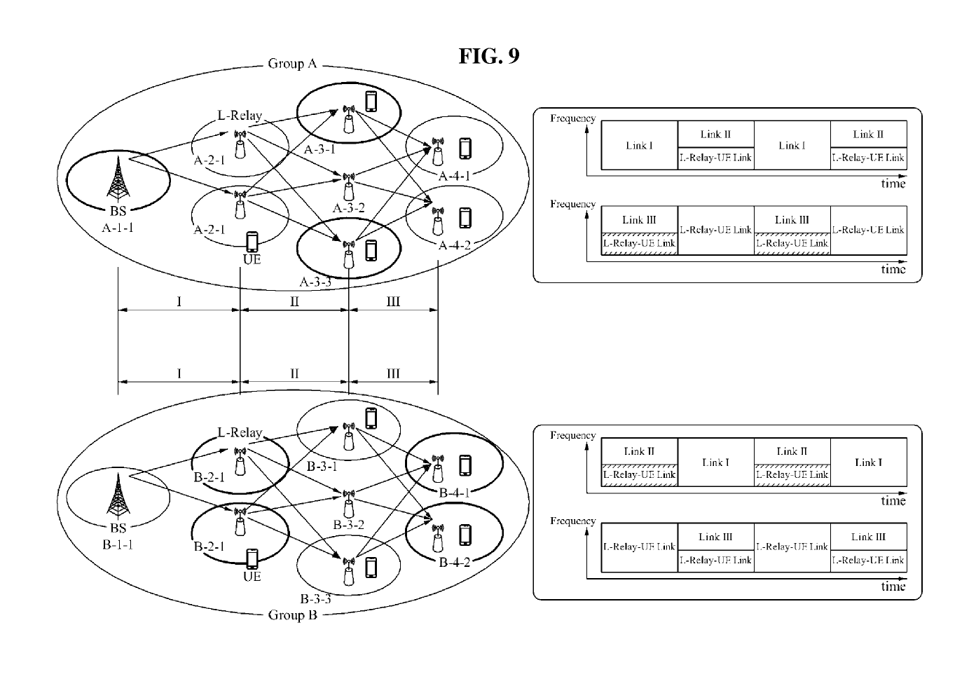

FIG. 9 illustrates resource reuse between cooperative groups situated near one another in a communication method for multi-hop multi-session transmission. Referring to FIG. 9, the resource reuse is implemented in the two cooperative groups situated near one another, for example, a group A and a group B. For example, in a first slot, Links I and III of the group A are scheduled, and Links II and UE of the group B are scheduled, to increase the resource reuse.

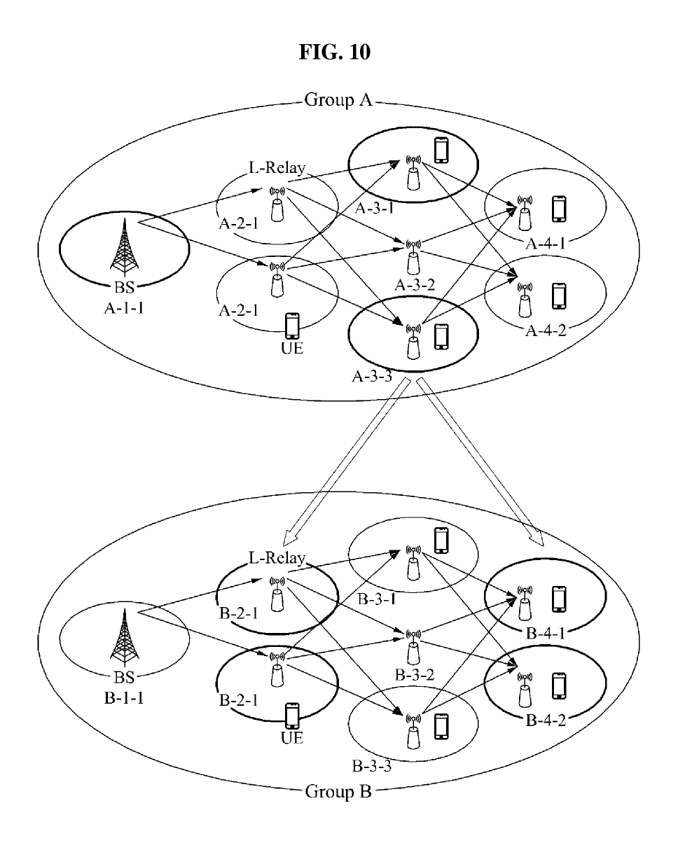

FIG. 10 illustrates interference reduction between cooperative groups situated near one another in a communication method for multi-hop multi-session transmission. Taking the resource reuse of FIG. 9 as an example, the node A-3-3 of the group A influences a significant interference on the nodes B-2-1 and/or B-4-1 of the group B.

Among nodes included in each of links, a node influencing a interference on a link of a neighboring cooperative group may be recognized to be a boundary node, and transmission power control and/or beamforming may be performed on the boundary node to reduce the interference on the neighboring cooperative group. For this purpose, the communication apparatus may assign a group ID to each of cooperative groups of links that operate in cooperation with one another to transmit data concurrently via light relays, may exchange group IDs, and may recognize a boundary node. Also, the communication apparatus may perform the transmission power control and/or the beamforming to reduce the interference on the light relays or nodes operating in cooperation with one another to transmit data concurrently.

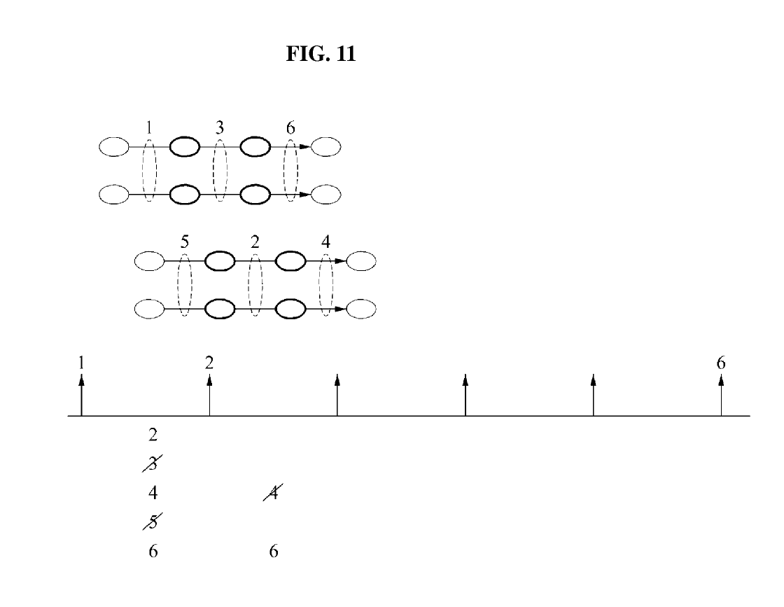

FIG. 11 illustrates distributed link scheduling for sessions in each of cooperative groups in a communication method for multi-hop multi-session transmission. Referring to FIG. 11, the distributed link scheduling for the sessions in each of the cooperative groups is based on cooperative group yielding.

In more detail, a communication apparatus sets a link priority of each of the sessions in each of the cooperative groups. The link priority may be set by, for example, a weighted setting method or a random setting method.

The communication apparatus conducts a yielding check on each of the sessions based on the link priority of each of the sessions. Based on a result of the yielding check on each of the sessions, the communication apparatus determines whether data placed in a corresponding session is to be transmitted (e.g., not yield) at a current time slot. The communication apparatus executes the distributed link scheduling for each of the sessions based on the result of the yielding check on each of the sessions.

Referring to FIG. 11, for example, when the link priority is given by session 1>session 3>session 6, and session 5>session 2>session 4, sessions 2, 4, and 6 are less subject to influences caused by data transmission from session 1, and any of the sessions 2, 4, and 6 may be a session operating in cooperation with session 1 to transmit data. Accordingly, in a first hop, the session 2 including the highest link priority among sessions 2, 4, and 6 transmits data. In a next hop, the sessions 4 and 6 are less subject to influences caused by data transmission from session 2, and the session 6 transmits data. A further detailed description of the cooperative group yielding is provided with reference to FIG. 12.

FIG. 12 illustrates transmitter group yielding and receiver group yielding in a communication method for multi-hop multi-session transmission. Taking the network of FIG. 2 as an example, after cooperative groups are formed, link scheduling for each of sessions in each of the cooperative groups may be determined.

For spatial reuse in a random network, distributed link scheduling based on group yielding may be performed. For example, referring to FIG. 12, a light relay 1 and a light relay 2 of a first cooperative group CMUG(1) forms a link CL(1,1), and a light relay 3 and a light relay 4 of a second cooperative group CMUG(2) forms a link CL(2,1). The link CL(1,1) includes a higher link priority than that of the link CL(2,1). The link priority may be determined based on, for example, a queue length, a random value, and/or values known to one of ordinary skill in the art.

In the network, data may be transmitted from the link CL(1,1) to the link CL(2,1), as shown in a left side of FIG. 12. When an intensity of signals transmitted from a transmitter end of the link CL(1,1) to a receiver end of the link CL(2,1) is greater than a predetermined threshold value, the link CL(2,1) is influenced significantly by interference even though the link CL(2,1) receives signals from the light relays 3 and 4. Accordingly, the link CL(2,1) may not transmit (e.g., may yield) the signals from the light relays 3 and 4. This is termed receiver group yielding.

When a transmitter end of the link CL(2,1) influences a significant interference on a receiver end of the scheduled link CL(1,1), as shown in a right side of FIG. 12, the link CL(1,1) may not transmit (e.g., may yield) the signals from the light relays 1 and 2. This is termed transmitter group yielding.

The links in the network may include a preassigned priority, or may be assigned with a priority based on a predetermined rule. Time synchronization may be executed based on the assigned priority, and a yielding check described in the foregoing may be conducted in a sequential order.

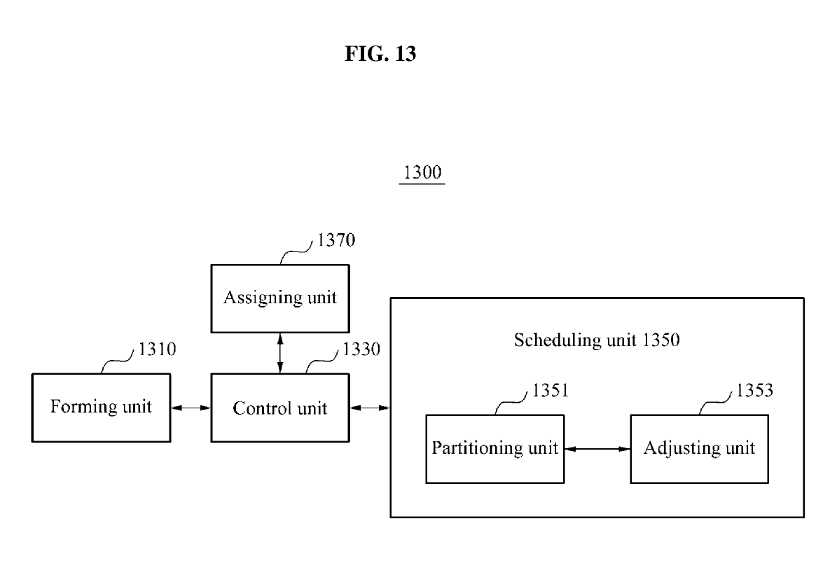

FIG. 13 illustrates a communication apparatus 1300 for multi-hop multi-session transmission. Referring to FIG. 13, the communication apparatus 1300 includes a forming unit 1310, a control unit 1330, a scheduling unit 1350, and an assigning unit 1370. The scheduling unit 1350 includes a partitioning unit 1351 and an adjusting unit 1353.

The forming unit 1310 forms cooperative groups of links operating in cooperation with one another to transmit data concurrently over transmission sessions via light relays of a network. The forming unit 1310 may form the cooperative groups based on a sum of DoFs determined based on associations among the light relays. The forming unit 1310 may form the cooperative groups based on a network capacity determined based on a transmission power of the light relays and channel information including transmission beamforming.

The control unit 1330 controls interference among the cooperative groups. For example, the control unit 1330 may control the interference by adjusting the transmission power among the cooperative groups based on a number of sessions in each of the cooperative groups. In another example, the control unit 1330 may control the interference by adjusting the transmission power based on a channel value among the cooperative groups.

The scheduling unit 1350 executes link scheduling for each of the sessions in each of the cooperative groups. The scheduling unit 1350 may execute distributed link scheduling for each of the sessions based on cooperative group yielding.

The partitioning unit 1351 performs spatial frequency resource partitioning for data being relayed by the light relays included in each of the sessions, and for data placed in nodes connected to the light relays included in each of the sessions.

The adjusting unit 1353 adjusts a region of a frequency resource dynamically at a relative traffic ratio of a link for data being relayed by the light relays, and a link for data placed in the nodes connected to the light relays.

The assigning unit 1370 assigns a cooperative group ID to each of the cooperative groups of the sessions operating in cooperation with one another to transmit data via the light relays.

The various units and methods described above may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may include various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions that control a processing device to implement a software component may include a computer program, a piece of code, an instruction, or some combination thereof, that independently or collectively instructs or configures the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments that implement the examples disclosed herein can be easily constructed by a programmer skilled in the art to which the examples pertain based on the drawings and their corresponding descriptions as provided herein.

As a non-exhaustive illustration only, a terminal described herein may be a mobile device, such as a cellular phone, a personal digital assistant (PDA), a digital camera, a portable game console, an MP3 player, a portable/personal multimedia player (PMP), a handheld e-book, a portable laptop PC, a global positioning system (GPS) navigation device, a tablet, a sensor, or a stationary device, such as a desktop PC, a high-definition television (HDTV), a DVD player, a Blue-ray player, a set-top box, a home appliance, or any other device known to one of ordinary skill in the art that is capable of wireless communication and/or network communication.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A communication method for multi-hop multi-session transmission, the communication method comprising:
forming groups of links operating in cooperation with one another to transmit data concurrently over sessions via relays;
controlling interference between the groups; and
scheduling the links for the sessions.

2. The communication method of claim 1, wherein the relays operate in cooperation with one another to amplify or quantize and forward mixed signals received from different nodes.

3. The communication method of claim 1, wherein the forming of the groups comprises:
forming the groups based on a sum of degrees of freedom (DoFs) of a network to which the relays belong.

4. The communication method of claim 3, wherein the forming of the groups further comprises:
determining the sum of DoFs based on associations among the relays.

5. The communication method of claim 3, wherein the forming of the groups further comprises:
maximizing the sum of DoFs based on whether a sum of amounts of interference influencing the groups reaches a threshold value determined based on a distance between nodes in the groups and a distance between the groups.

6. The communication method of claim 1, wherein the forming of the groups further comprises:
forming the groups based on a capacity of a network to which the relays belong.

7. The communication method of claim 6, wherein the forming of the groups comprises:
determining the capacity based on a transmission power of the relays and channel information comprising transmission beamforming.

8. The communication method of claim 1, wherein the controlling of the interference comprises:
adjusting a transmission power among the groups based on a number of links in each of the groups.

9. The communication method of claim 1, wherein the controlling of the interference comprises:
adjusting a transmission power among the groups based on a channel value among the groups.

10. The communication method of claim 1, wherein the scheduling of the links comprises:
executing distributed scheduling of the links for the sessions based on yielding of the groups.

11. The communication method of claim 10, wherein the executing of the distributed scheduling comprises:
setting a priority of each of the sessions;
executing a yielding check on the sessions based on the priority; and
executing the distributed scheduling based on a result of the yielding check.

12. The communication method of claim 1, wherein the scheduling of the links comprises:
partitioning a frequency resource for data being relayed by the relays, and data placed in nodes connected to the relays.

13. The communication method of claim 12, wherein the scheduling of the links further comprises:
adjusting a region of the frequency resource at a relative traffic ratio of a link for the data being relayed by the relays, and a link for the data placed in the nodes connected to the relays.

14. The communication method of claim 1, further comprising:
assigning a group identification (ID) to each of the groups.

15. The communication method of claim 1, further comprising:
transmitting data to the groups, using a radio resource comprising a millimeter wave (mmWave) band.

16. A non-transitory computer-readable storage medium storing a program comprising instructions to cause a computer to perform the method of claim 1.

17. A communication apparatus for multi-hop multi-session transmission, the communication apparatus comprising:
a forming unit configured to form groups of links operating in cooperation with one another to transmit data concurrently over sessions via relays;
a control unit configured to control interference between the groups; and
a scheduling unit configured to schedule the links for the sessions.

18. The communication apparatus of claim 17, wherein the forming unit is further configured to:
determine a sum of degrees of freedom (DoFs) of a network to which the relays belong based on associations among the relays; and
form the groups based on the sum of DoFs.

19. The communication apparatus of claim 17, wherein the forming unit is further configured to:
determine a capacity of a network to which the relays belong based on a transmission power of the relays and channel information comprising transmission beamforming; and
form the groups based on the capacity.

20. The communication apparatus of claim 17, wherein the control unit is further configured to:
adjust a transmission power among the groups based on a number of links in each of the groups.

21. The communication apparatus of claim 17, wherein the control unit is further configured to:
adjust a transmission power among the groups based on a channel value among the groups.

22. The communication apparatus of claim 17, wherein the scheduling unit is further configured to:
execute distributed scheduling of the links for the sessions based on yielding of the groups.

23. The communication apparatus of claim 17, wherein the scheduling unit further comprises:
a partitioning unit configured to partition a frequency resource for data being relayed by the relays, and data placed in nodes connected to the relays.

24. The communication apparatus of claim 23, the scheduling unit further comprises:
an adjusting unit configured to adjust a region of the frequency resource at a relative traffic ratio of a link for the data being relayed by the relays, and a link for the data placed in the nodes connected to the relays.

25. The communication apparatus of claim 17, further comprising:
an assigning unit configured to assign a group identification (ID) to each of the groups.
